(19) United States
(12) Patent Application Publication
(10) Pub. No.: US 2025/0303393 A1
(43) Pub. Date: Oct. 2, 2025

(54) LIQUID CONTAMINANT ABSORBENT AND A METHOD FOR FABRICATING A LIQUID CONTAMINANT ABSORBENT

(71) Applicant: The University of Hong Kong, Pok Fu Lam (HK)

(72) Inventors: Lingyue Zhang, Pok Fu Lam (HK); Chuyang Tang, Pok Fu Lam (HK); Pengfei Sun, Pok Fu Lam (HK)

(21) Appl. No.: 19/077,225

(22) Filed: Mar. 12, 2025

Related U.S. Application Data
(60) Provisional application No. 63/570,323, filed on Mar. 27, 2024.

(51) Int. Cl. B01J 20/30; B01J 20/26; B01J 20/28; B01J 20/34; C02F 1/28; C02F 101/30

(52) U.S. Cl. CPC B01J 20/3057; B01J 20/268; B01J 20/28007; B01J 20/28083; B01J 20/3078; B01J 20/3475; C02F 1/285; C02F 2101/301; C02F 2305/08

(57) ABSTRACT

A liquid contaminant absorbent and a method for fabricating a liquid contaminant absorbent. The method includes the steps of: mixing polydopamine nanospheres (SPDA) with a template agent in a predetermined mixing ratio to form a precursor mixture; dissolving the precursor mixture in a solvent to initiate a reaction within the precursor mixture; obtaining a precipitate from the precursor mixture after a predetermined reaction period; and removing the template agent from the precipitate to obtain mesoporous polydopamine nanoparticles (MPDA).

### FIELD OF THE INVENTION

The invention relates to a liquid contaminant absorbent and a method for fabricating a liquid contaminant absorbent, and particularly, although not exclusively, to a method for fabricating a liquid contaminant absorbent for removing surfactant-like contaminants from wastewater.

### BACKGROUND OF THE INVENTION

The detrimental environmental impacts of surfactant-like contaminants (SLCs), characterized by their unique amphiphilic structures, have gained considerable attention, especially since perfluorooctane sulfonate was designated as a persistent organic pollutant. Polydopamine (PDA), is an eco-friendly polymer and nanoparticle, has attracted significant interest due to its self-polymerization properties. PDA nanomaterials have exhibited a remarkable ability to adsorb environmental pollutants. In comparison to other carbon-based materials, PDA boasts an abundant active functional groups, nontoxicity, and feasible synthesis processes.

### SUMMARY OF THE INVENTION

In accordance with a first aspect of the present invention, there is provided a method for fabricating a liquid contaminant absorbent, comprising the steps of: mixing polydopamine nanospheres (SPDA) with a template agent in a predetermined mixing ratio to form a precursor mixture; dissolving the precursor mixture in a solvent to initiate a reaction within the precursor mixture; obtaining a precipitate from the precursor mixture after a predetermined reaction period; and removing the template agent from the precipitate to obtain mesoporous polydopamine nanoparticles (MPDA).

In accordance with the first aspect, the template agent includes a non-ionic surfactant.

In accordance with the first aspect, the template agent includes a plutonic F-127 template agent.

In accordance with the first aspect, the step of dissolving the precursor mixture in a solvent to initiate a reaction within the precursor mixture comprises the step of adjusting a system pH of the precursor mixture with an alkaline solution and maintaining the precursor mixture at a predetermined reaction temperature in the predetermined reaction period.

In accordance with the first aspect, the system pH is adjusted to 8.5, the predetermined reaction period is 24 hours and the predetermined reaction temperature is 80 degrees Celsius.

In accordance with the first aspect, the step of removing the template agent from the precipitate comprises the step of baking the precipitate at a predetermined baking temperature for a predetermined baking period.

In accordance with the first aspect, the predetermined baking temperature is in a range between 250 to 450 degrees Celsius.

In accordance with the first aspect, the predetermined baking temperature is at 350 degree Celsius.

In accordance with the first aspect, the method further comprises the step of preparing SPDA by: dissolving and stirring dopamine in Tris-HCl buffer solution for 24 hours at room temperature; obtaining pristine polydopamine nanoparticles (PDA) by freeze-frying precipitate separated from the mixture of dopamine in Tris-HCl buffer solution; dissolving and stirring PDA in ethanol and Tris-HCl buffer solution for 24 hours; and obtaining SPDA by freeze-drying precipitate separated from the mixture of PDA in ethanol and Tris-HCl buffer solution.

In accordance with the second aspect of the present invention, there is provided a liquid contaminant absorbent having a mesoporous nanostructures formed on a surface of the polydopamine particles.

In accordance with the second aspect, the polydopamine particles is adapted to remove surfactant-like contaminants (SLCs) from wastewater.

In accordance with the second aspect, the polydopamine particles is arranged to remove SLCs from wastewater by adsorption.

In accordance with the second aspect, the polydopamine particles are fabricated in accordance with the method of the first aspect.

In accordance with the third aspect of the present invention, there is provided a method of regenerating a liquid contaminant absorbent for removing SLCs from wastewater, comprising the step of providing polydopamine particles in accordance with the second aspect being used for removing a predetermined amount of SLCs from wastewater, and removing SLCs from the polydopamine particles to regenerate an SLC removal power of the MPDA.

In accordance with the third aspect, the step of removing SLCs from the polydopamine particles includes a SLCs desorption process.

In accordance with the third aspect, the polydopamine particles is processed by ethanol as an eluant to remove the SLCs from the surface of the polydopamine particles.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the present invention will now be described, by way of example, with reference to the accompanying drawings in which:

FIG. 1A is a schematic diagram of the fabrication of MPDA in accordance with an embodiment of the present invention

FIG. 1B is a schematic diagram showing the selective SLCs removal mechanism in the MPDA fabricated in accordance with the method of FIG. 1A.

FIG. 2A illustrates the pore size distribution (a) of MPDA fabricated in accordance with an embodiment of the present invention at different template removal temperatures.

FIG. 2B illustrates the SLCs removal rate and the adsorption affinity of MPDA fabricated in accordance with an embodiment of the present invention at different template removal temperatures.

FIG. 3 shows SEM images of PDA, SPDA, and MPDA fabricated in accordance with an embodiment of the present invention.

FIG. 4 illustrates the isotherm and fitting results of SLCs adsorption on polydopamine nanostructures fabricated in accordance with an embodiment of the present invention.

FIG. 5A shows the SEM images of polydopamine nanospheres.

FIG. 5B shows the pore size distribution of polydopamine nanospheres.

FIG. 5C shows the FTIR spectra of polydopamine nanospheres.

FIG. 5D shows the XPS spectra of polydopamine nanospheres.

FIG. 5E shows the C is core region of polydopamine nanospheres.

FIG. 6A illustrates the adsorption isotherms of polydopamine nanospheres.

FIG. 6B illustrates the kinetics of polydopamine nanospheres.

FIG. 6C intraparticle diffusion and fitting results for the adsorption of LAS.

FIG. 6D illustrates the ζ-potential of polydopamine nanospheres as a function of pH.

FIG. 6E illustrates effects of pH value on SLCs adsorption.

FIG. 6F illustrates FTIR spectra of PDA and PDA at the system pH of 12.

FIG. 7A shows the pore size distribution of MPDA at different template removal temperatures.

FIG. 7B shows the adsorption affinity of MPDA at different template removal temperatures.

FIG. 7C shows XPS spectra of MPDA at different template removal temperatures.

FIG. 7D shows removal rate and the adsorption affinity of polydopamine nanospheres with different particle size.

FIG. 8A shows XPS spectra of MPDA before and after LAS adsorption.

FIG. 8B shows FTIR spectra of polydopamine nanospheres after LAS adsorption and standard LAS samples.

FIG. 8C shows the isotherm and fitting results of SLCs adsorption on polydopamine nanospheres.

FIG. 8D shows nuclear magnetic decay curve with the calculated T2 value of polydopamine nanospheres with H2O as the probe molecule.

FIG. 8E shows multicomponent inversion of time-domain nuclear magnetic resonance spectra of polydopamine nanospheres with H2O as the probe molecule.

FIG. 9A illustrates a schematic of the cycling process of MPDA on wastewater matric.

FIG. 9B illustrates adsorption and desorption rate of LAS with MPDA absorbent, where the initial concentration of LAS is 20 mg/L and the dosage of MPDA powder absorbent is 1 g/L.

FIG. 9C illustrates the SLCs concentration of the sampled highly contaminated wastewater before and after MPDA adsorption, where the average TOC of the 6 wastewater samples is 1026 mg/L.

FIG. 10 illustrates the nitrogen adsorption isotherm of PDA, SPDA, and MPDA and pore size distribution.

FIG. 11 illustrates the N is core region of PDA, SPDA, and MPDA.

FIG. 12 illustrates the O is core region of PDA, SPDA, and MPDA.

FIG. 13 illustrates SEM images of PDA at the system pH of 12.

FIG. 14 illustrates the O is core region of MPDA at different template removal temperatures.

FIG. 15 illustrates SEM images of PDA, SPDA, and MPDA with different particle size.

### DETAILED DESCRIPTION OF ILLUSTRATIVE EMBODIMENTS

The inventors devised that surfactants serve as common detergents and solubilizers in various industrial and daily life applications, often discharging into environmental water bodies. These contaminants, known as surfactant-like contaminants (SLCs), exhibit both hydrophilic (polar) and hydrophobic (lipophilic) properties, rendering them a subject of extensive research in the field of wastewater treatment due to their detrimental direct and indirect environmental effects. The distinctive amphiphilic nature and accumulation characteristics of SLCs can lead to severe biotoxicity, pollutant dissolution, and eutrophication of water bodies. Notably, the classification of perfluorooctane sulfonate (PFOS) as a persistent organic pollutant in 2009 underscores the crucial significance of effective SLCs removal in wastewater treatment.

Various carbon-based nanomaterials, minerals, and metal oxides may be used for the removal of SLCs from wastewater, and polydopamine (PDA) nanomaterials may have a comparable ability to adsorb environmental pollutants. Compared to other carbon-based materials, PDA possess abundant active functional groups, nontoxicity, and feasible synthesis processes. However, PDA nanoparticles tend to stack with each other during the synthesis process, with pores primarily composed of micropores smaller than 2 nm, resulting in relatively low specific surface area and limited contaminations removal capacity.

Despite the widespread application of various absorbents for SLCs removal as abovementioned, the reported interaction mechanisms for SLCs removal, such as hydrophobic interactions, ligand exchange, and electrostatic interactions, remain speculative and lack quantitative characterization methods and experimental evidence. The limited understanding on elucidating the adsorption mechanisms of SLCs has resulted in reduced removal efficiency of SLCs from contaminated water by these example adsorption materials, primarily due to significant competitive effects.

To address this, a novel approach for the fabrication of mesoporous polydopamine nanospheres (MPDA) using a soft-template method is provided, for enhancing the removal efficiency of SLCs. Inventors conducted adsorption isotherms and kinetics experiments to evaluate the adsorption behavior of MPDA. Additionally, inventors employed low-field nuclear magnetic resonance (LF-NMR) to quantitatively characterize the surface hydrophilicity of MPDA. By manipulating the system's pH to reach the isoelectric point and conducting a comparative analysis of SLCs with different chemical structures, inventors elucidated the interaction mechanism underlying the selective removal of SLCs by MPDA. These mechanistic insights highlight the significant potential of mesoporous polydopamine nanospheres as efficient adsorbents for SLCs, offering a feasible strategy for the selective removal of SLCs from wastewater. In addition, the inventors further devised mechanistic insights into the removal of surfactant-like contaminants on mesoporous polydopamine nanospheres from complex wastewater matrices.

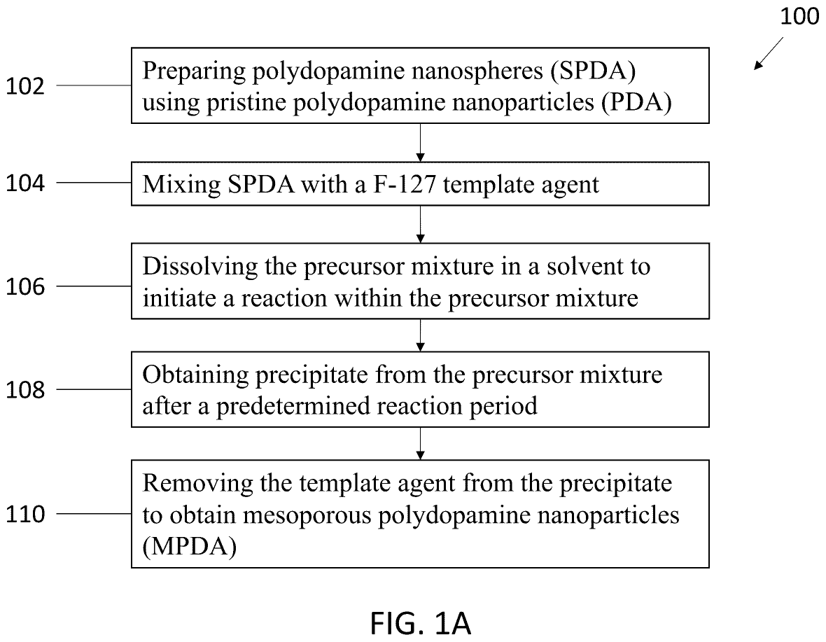

With reference to FIGS. 1A to 1B there is shown an embodiment of a fabrication of MPDA and the selective SLCs removal mechanism. In this embodiment, the method 100 comprises the steps of: at step 104, mixing polydopamine nanospheres (SPDA) with a template agent in a predetermined mixing ratio to form a precursor mixture; at step 106, dissolving the precursor mixture in a solvent to initiate a reaction within the precursor mixture; at step 108, obtaining a precipitate from the precursor mixture after a predetermined reaction period; and at step 110 removing the template agent from the precipitate to obtain mesoporous polydopamine nanoparticles (MPDA).

In this embodiment, the synthesis pathway for obtaining MPDA begins with polymerizing dopamine to obtain polydopamine nanoparticles (PDA) 10, then PDA 10 will be modified to become polydopamine nanospheres (SPDA) 11 which may be used as a filter material for absorbing SLCs, and the absorbing/filtering efficiency may be further enhance by providing the nanospheres with a mesoporous nanostructure. In this disclosure, the polydopamine nanospheres having mesoporous nanostructure is referred as mesoporous polydopamine nanoparticles (MPDA) 12.

In one exemplary embodiment, the method 100 may begin with step 102, where SPDA may be prepared by: dissolving and stirring dopamine in Tris-HCl buffer solution for 24 hours at room temperature; obtaining pristine polydopamine nanoparticles (PDA) by freeze-frying precipitate separated from the mixture of dopamine in Tris-HCl buffer solution; dissolving and stirring PDA in ethanol and Tris-HCl buffer solution for 24 hours; and obtaining SPDA by freeze-drying precipitate separated from the mixture of PDA in ethanol and Tris-HCl buffer solution.

Preferably, the soft-template method was innovatively applied to fabricate mesoporous polydopamine nanostructures with high Brunauer-Emmett-Teller (BET) surface area. Advantageously, PDA may be modified to become MPDA which has a much higher surface area for adsorbing specific types of contaminants in waste water, such as SLCs 14. In this invention, MPDA 12 may be used as a liquid contaminant absorbent for removing SLCs 14 from waste water 16 by adsorption.

SLCs are amphipathic molecules, and usually these molecules possess both hydrophilic (polar charged or uncharged head group) and hydrophobic (non-polar hydrocarbon tail) properties. Adsorption may be a major filtering mechanism of PDA-based filter material for filtering SLCs, thus an increase of a number of adsorption sites on each of the nanoparticles may be realized by increasing an effective surface area of the nanoparticles, e.g. by providing the PDA nanoparticles in a porous or mesoporous form, such that a larger amount of SLCs may be trapped by each nanoparticle at the surface.

For example, by including MPDA 12 in a certain filtering stage in a waste water treatment plant, the MPDA 12 filter can bind to heavy metals and organic pollutants due to the presence of functional moieties, such as catechol, amine, and phenyl groups. This makes them effective in adsorbing these pollutants from wastewater 16.

Preferably, the mesoporous polydopamine nanostructures may be fabricated via two major steps: 1. regulation of polydopamine polymerization; and 2. construction and regulation of MPDA nanostructure.

To regulate the polymerization of dopamine, a non-ionic surfactant, such as a plutonic F-127 template agent, may be induced as a soft-template for defining the mesoporous nanostructure. F-127 template is a triblock copolymer composed of poly(ethylene oxide)-poly(propylene oxide)-poly(ethylene oxide) (PEO-PPO-PEO), which may be used as a template in the synthesis of mesoporous films and particles, and it allows for the creation of materials with controlled pore sizes on the surface of the film or particle, e.g. after being removed from the surface.

Preferably, the step of dissolving the precursor mixture in a solvent to initiate a reaction within the precursor mixture comprises the step of adjusting a system pH of the precursor mixture with an alkaline solution and maintaining the precursor mixture at a predetermined reaction temperature in the predetermined reaction period.

In one example embodiment, different masses of F-127 and dopamine (with a mass ratio of 2:1) may be first dissolved in 100 mL of ultrapure water at room temperature. After dissolving, the system pH may be adjusted to alkaline, such as using ammonia to adjust 8.5, and continue the reaction for 24 hours at 80° C. The resulting solution was a liquid suspension of polydopamine nanoparticles. The obtained dispersion was centrifuged at 13,000 rpm for 10 minutes and rinsed three times with ultrapure water to remove excess soft template agents and dopamine. The black powder precipitate was freeze-dried and collected.

MPDA nanostructures may be further constructed and regulated, by baking the precipitate obtained from the precursor mixture after the abovementioned reaction to remove the template agent from the templated SPDA nanospheres. To further remove the soft template agent, thermal treatment was applied to construct mesoporous morphology. The resulting precipitate from the first step was placed in a tube furnace from 20° C. to 450° C. under Ar protection. After cooling to room temperature, the obtained powder was named as MPDA and stored in a brown reagent bottle.

In the experiment carried out by the inventors, Hydrochloric acid (HCl, 36-38%), sodium hydroxide (NaOH, >98%), Pluronic F-127 (F-127, (C₃H₆O·C₂H₄O)ₓ, analytical standard grade) and ammonium acetate (LC/MS grade, >99%) were purchased from Sigma-Aldrich (Shanghai, China). Methanol (HPLC grade, 99.9%) was purchased from Fisher Chemical (Leicestershire, England). Dopamine hydrochloride (C₈H₁₁NO₂HCl, 98%), sodium dodecyl benzene sulfonate standard solution (LAS, C₁₈H₂₉SO₃Na, analytical standard grade), sodium dodecyl sulfonate (SDLS, C₁₂H₂₅SO₃Na, >99.0%), and tris hydrochloric acid buffer (Tris, pH=8.5) were purchased from Aladdin (Shanghai, China). Potassium perfluorooctyl sulfonate (PFOS, C₈F₁₇SO₃K, >98%) was purchased from Merida (Beijing, China). Anhydrous ethanol (C₂H₆O, >99.7%) was purchased from Titan (Shanghai, China). Ammonia (NH₃·H₂O, 25%-28%) was purchased from Macklin (Shanghai, China). The ultrapure water used to prepare the solution is prepared by Master-S UV ultrapure water machine.

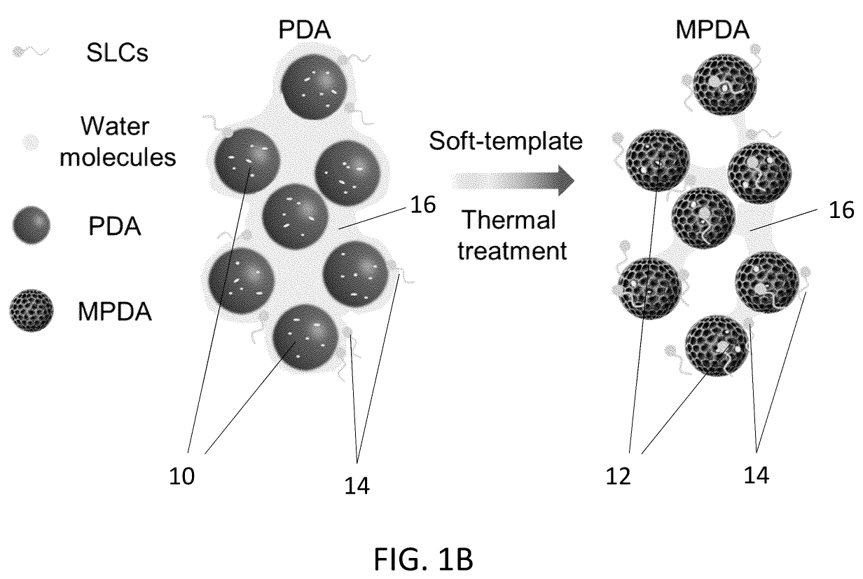

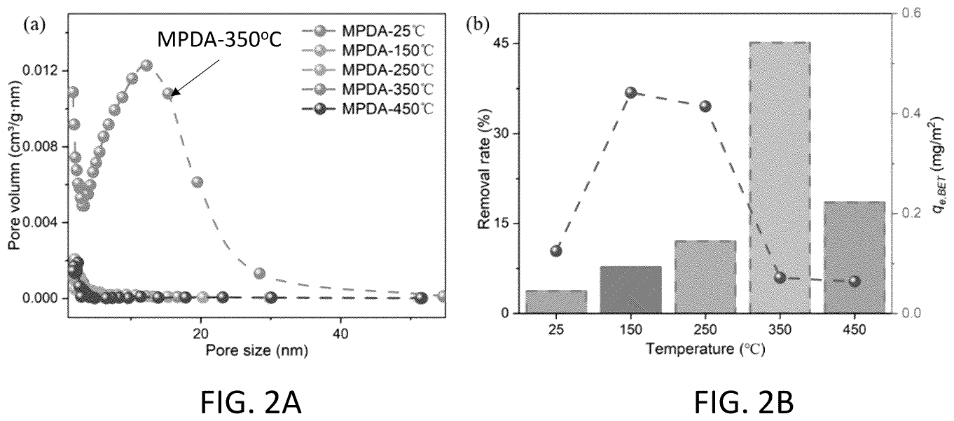

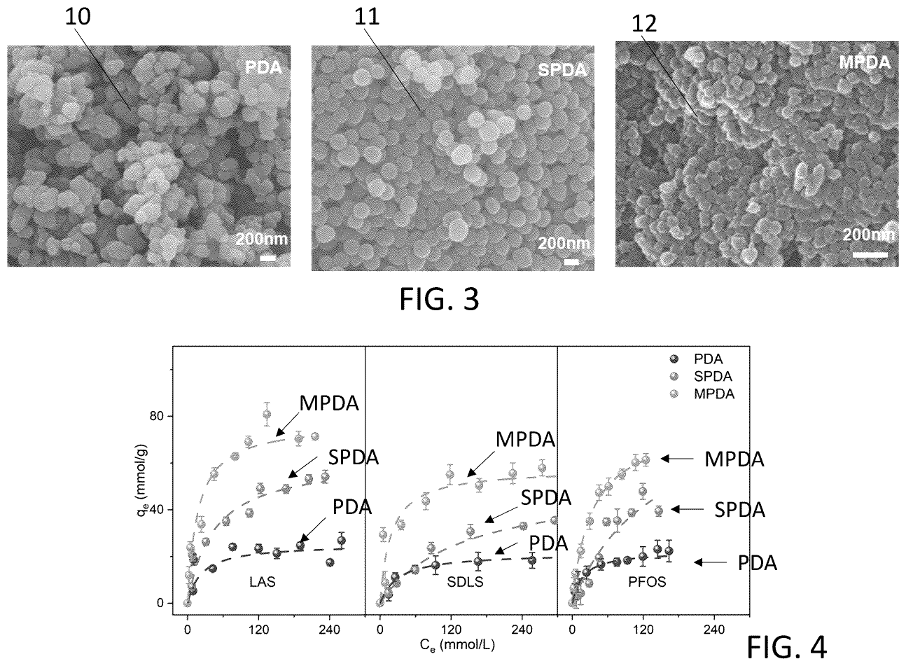

With reference to FIGS. 2A and 2B, the pore size distribution of MPDA were analyzed at different temperatures. It was observed that the baking temperature is preferably in a range between 250 to 450 degrees Celsius, and more preferable at 350 degrees Celsius.

In this exemplary embodiment, when the template removal temperature ranged from 25° C. to 250° C., the specific surface area of MPDA showed minimal changes, indicating a lack of mesoporous structure formation and insignificant removal effect of the soft template agent. However, at a template removal temperature of 350° C., the specific surface area of MPDA significantly increased to 126.52 m²/g, with the specific surface area of Barrett-Joyner-Halenda mesopores reaching 95.22 m²/g. This suggests that the formation of mesopores is the main factor contributing to the overall increase in specific surface area.

Conversely, at a template removal temperature of 450° C., the specific surface area of MPDA decreased to 58.01 m²/g, primarily due to a significant reduction in mesoporous specific surface area to 3.86 m²/g. In this case, the specific surface area of micropores dominates. Comparing the adsorption performance of MPDA on SLCs at different template removal temperatures, inventors observed a consistent trend with the changes in specific surface area. MPDA-350° C. exhibited the best adsorption effect, with a SLCs removal rate of 45.14%. At template removal temperatures between 25° C. and 250° C., the adsorption removal rate of SLCs gradually increased, albeit with small increments, ranging from 3.75% to 12.01%.

As described earlier, polydopamine particles may be used to remove SLCs from wastewater by adsorption. The adsorption experiments on PDA with different structures were carried out at ambient temperature using a batch approach by the inventors. To start the experiment, 200 mg of the absorbent was added to 200 mL of a solution containing SLCs (sodium dodecyl benzene sulfonate standard solution (LAS), sodium dodecyl sulfonate (SDLS), and potassium perfluorooctyl sulfonate (PFOS)) with various initial concentrations ranging from 5-100 mg/L. With stirring at 200 rpm, samples were taken at specific times for analysis of adsorption kinetics and isotherms at adsorption equilibrium (24 h). The pH of the solution was adjusted using 0.1 M NaOH and 0.1 M HCl, and monitored using a pH meter (T50, Mettler Toledo, Switzerland). All adsorption experiments were performed in duplicate.

In the experiment, pristine polydopamine nanoparticles (PDA) was synthesized, where dopamine (2 g/L) may be dissolved in 20 mL Tris-HCl buffer (pH=8.5, 10 mmol) and mixed for 24 hours using a magnetic stirrer at room temperature. The resulting polydopamine solution may then be centrifuged at 13,000 rpm for 10 minutes and rinsed three times with ultrapure water. The resulting precipitate may be freeze-dried for 24 hours and stored in brown reagent bottles.

In addition, polydopamine nanostructures (SPDA) may be regulated by increasing the proportion of organic phase in solvent system, which can be achieved by dissolving dopamine in a mixed solution of 20% (v/v) ethanol and Tris-HCl buffer solution (pH=8.5, 10 mmol), after stirring for 24 hours, the resulting solution may be centrifugated and rinsed with ethanol and ultrapure water, finally, SPDA may be freeze-dried and collected as black powder.

With reference to FIGS. 2A and 2B, to further validate the selective adsorption capacity of MPDA on SLCs, a horizontal comparison was conducted using multiple SLCs, including traditional surfactants and perfluorinated compounds. Take LAS adsorption for example, the fitting results of the Freundlich adsorption isotherm model reveal that the 1/n values for PDA, SPDA, and MPDA after fitting are 0.26, 0.40, and 0.28, respectively, indicating that LAS has a tendency to be adsorbed by polydopamine nanospheres. The maximum adsorption capacities of LAS on PDA, SPDA, and MPDA materials are 10.58 mg/g, 14.11 mg/g, and 16.35 mg/g, respectively, demonstrating that the mesoporous structure of MPDA can significantly enhance the adsorption capacity of LAS.

Advantageously, the designed MPDA remarkable selective adsorption performance for SLCs, surpassing both PDA and SPDA in terms of equilibrium adsorption capacity. Compared to PDA and SPDA, MPDA exhibited more than 2-fold enhancement in SLCs adsorption capacity with specific surface area significantly increased to 126.52 m²/g.

In addition, the dominant effects of electrostatic and hydrophobic interactions on the selective removal of SLCs with MPDA are demonstrated by regulating the isoelectric pH value and performing a comparative analysis. The mechanism-inspired SLCs removal strategy achieved an average removal rate of 76.3% from highly contaminated wastewater. New findings offer new avenues for the application of MPDA as an efficient adsorbent and provide innovative and mechanistic insights for targeted SLCs removal in complex wastewater matrices.

After passing through 0.22 μm membranes, the inventors conducted quantitative analysis of the samples using Acquity UPLC (Waters, USA) coupled with a Xevo TQD (Waters, United States) triple quadrupole tandem mass spectrometry (MS/MS). The detailed optimization methods were developed with the post-column compensation method to enhance the detection limit with 30 L/min of 10% ammonium hydroxide in water. In brief, inventors performed gradient elution using a BEH-C18 column (1.7 μm, 2.1×100 mm, Waters, USA) and 5 mM ammonium acetate and 0.5% (v/v) formic acid in water (A) and methanol (B). The specific gradient elution conditions and corresponding mass spectrum conditions were listed in Table S1 and S2 in this disclosure.

In the analysis, the pseudo-first-order (Eq. 1) and pseudo-second-order model (Eq. 2) was applied to fit the adsorption data of kinetic studies.

$${q}_{t} = {q}_{e} ( 1 - {e}^{- {k}_{1} t} ) \qquad ( 1 )$$

$${q}_{t} = \frac{{q}_{e}^{2} {k}_{2} t}{1 + {q}_{e} {k}_{2} t} \qquad ( 2 )$$

where qₜ (mg/g) is the adsorption amounts of pollutants at time t (min), qₑ (mg/g) is the adsorption amounts of pollutants at equilibrium time, and k₁ (mg/g/min) and k₂ (g/mg/min) is the rate constant. According to Eq. 2, initial adsorption rate was calculated as:

$${v}_{0} = {q}_{e}^{2} {k}_{2} \qquad ( 3 )$$

where v₀ (mg/g/min) is the initial adsorption rate. The diffusion mechanisms were conducted by fitting the intraparticle diffusion model (Eq. 4).

$${q}_{e} = {k}_{id} {t}^{1 / 2} + C \qquad ( 4 )$$

where k_{id} (mg·min^{1/2}/g) is the interparticle diffusion rate constant and C (mg/g) is the boundary layer thickness constant. The adsorption isotherms were simulated by the Langmuir (Eq. 5) and Freundlich model (Eq. 6).

$${q}_{e} = \frac{{q}_{m} {bC}_{e}}{1 + {bC}_{e}} \qquad ( 5 )$$

$${q}_{e} = {K}_{f} {C}_{e}^{\frac{1}{n}} \qquad ( 6 )$$

Cₑ (mg/L) is the residual pollutants in solution at equilibrium, qₘ is the maximum adsorption capacity, b is the constant of the Langmuir model, and K_{f} (mg·(L/mg)^{1/n}/g) and n are the constant of the Freundlich model. To systematically analyze the impact of morphology on the adsorption performance of surfactants, the adsorption capacity of nanoparticles per unit surface area (adsorption affinity) was calculated as:

$${q}_{e , BET} = \frac{{q}_{e}}{S} \qquad ( 7 )$$

where qₑ, BET (mg/m²) is the adsorption affinity of nanoparticles for the adsorbed pollutants, S (m²/g) is the measured BET specific surface area of nanoparticles.

The morphology of the adsorbents was observed using a Hitachi SU-8010 scanning electron microscope (SEM). Fourier transform infrared (FTIR) spectra were measured using a Bruker Vertex 70 in the range of 350-4000 cm⁻¹ to determine chemical groups. The Brunauer-Emmett-Teller (BET) and Barrett-Joyner-Halenda (BJH) equations were used with a Quantachrome SI-MP to calculate the surface area and pore size distribution. X-ray photoelectron spectroscopy (XPS) spectra were recorded in a Thermo ESCALAB 250XI to determine surface elemental composition and valency. The zeta potential was measured using a Zeta potentiometer (Delsa Nano C, Beckman Coulter). Notably, the hydrophilicity and water distribution characteristics of the adsorbents were quantified innovatively using LF-NMR with VTMR20-010V-I at approximately 0.5 T of main magnetic field. Prior to testing, the nanoparticles and water probe were balanced at a constant temperature of 40° C. for more than 30 minutes.

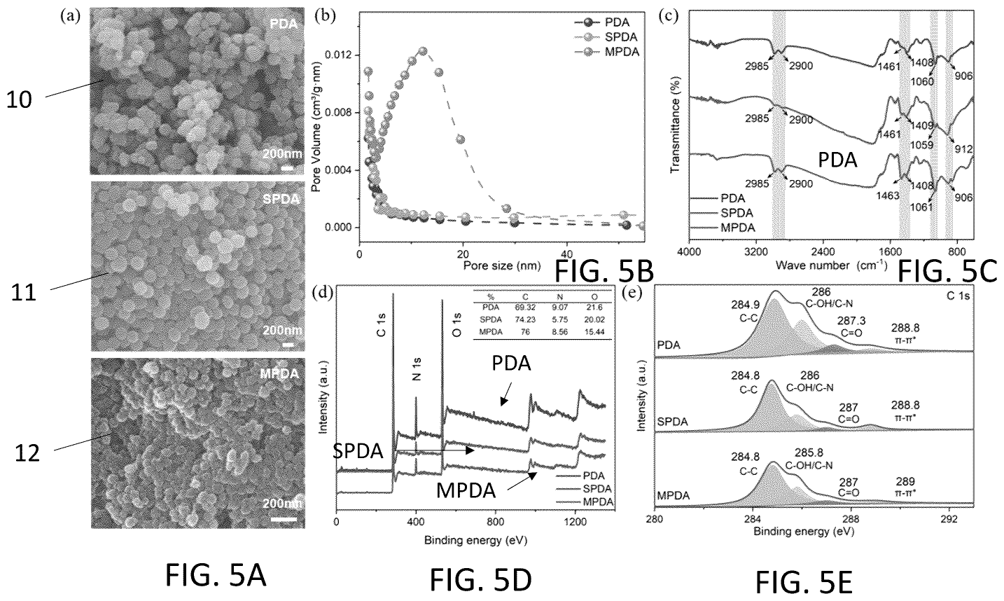

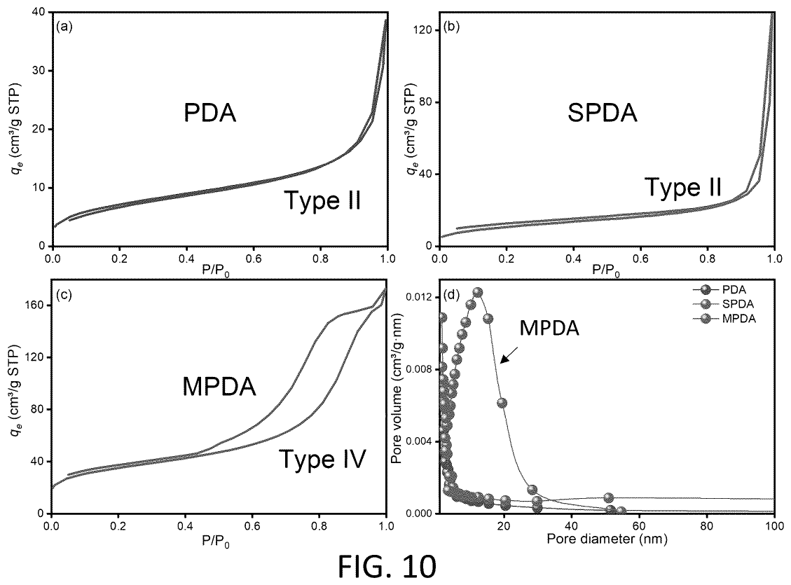

The inventors also analyzed stack and nanosphere polydopamine being synthesized to gain a better understanding of the effects of morphology on interaction mechanisms. With reference to FIG. 5A, the SEM images show that, unlike the stacked structure of PDA, SPDA and MPDA clearly exhibit spherical nano-architectures, with MPDA displaying obvious porous characteristics. The nitrogen adsorption isotherm curve of FIG. 10 and pore size distribution in results shown in FIG. 5B further confirm the mesoporous structure on the surface of MPDA. The type IV isotherm primarily arises due to the presence of mesopores and micropores in MPDA.

At lower relative pressures, the adsorption mechanism is similar to the type II isotherm, and the micropores gradually become saturated. At higher relative pressures, capillary condensation occurs in the mesopores, causing a rapid rise in the isotherm. A hysteresis phenomenon is clearly observed, where the desorption isotherm of the material does not coincide with the adsorption isotherm, and the desorption isotherm is higher than the adsorption isotherm. The pore size distribution results further confirm that PDA and SPDA mainly consist of micropores <2 nm, while MPDA is predominantly mesoporous, with a wide distribution ranging from 3 nm to 50 nm, with the most concentrated distribution at 12 nm. The pore size distribution results align with the SEM surface characterization results, indicating that MPDA synthesized using the soft template method possesses a stable mesoporous nanosphere structure.

The FTIR spectra of polydopamine nanomaterials are presented in FIG. 5C. The main functional group positions are generally consistent, and the chemical composition is primarily composed of characteristic functional groups of polydopamine. Specifically, the absorption peaks at 2900 cm⁻¹ and 2985 cm⁻¹ correspond to the C—H stretching vibrations of alkane saturated carbon atoms, while the peaks at 1408 cm⁻¹-1409 cm⁻¹ and 1461 cm⁻¹-1463 cm⁻¹ correspond to the stretching vibrations of the C═C bonds in the polydopamine benzene ring. Additionally, the peaks at 1059 cm⁻¹-1061 cm⁻¹ correspond to the stretching vibrations of the C—N bonds, and the peaks at 906 cm⁻¹ and 912 cm⁻¹ correspond to the out-of-plane bending vibrations of the C—H bonds in the aromatic hydrocarbon on the benzene ring.

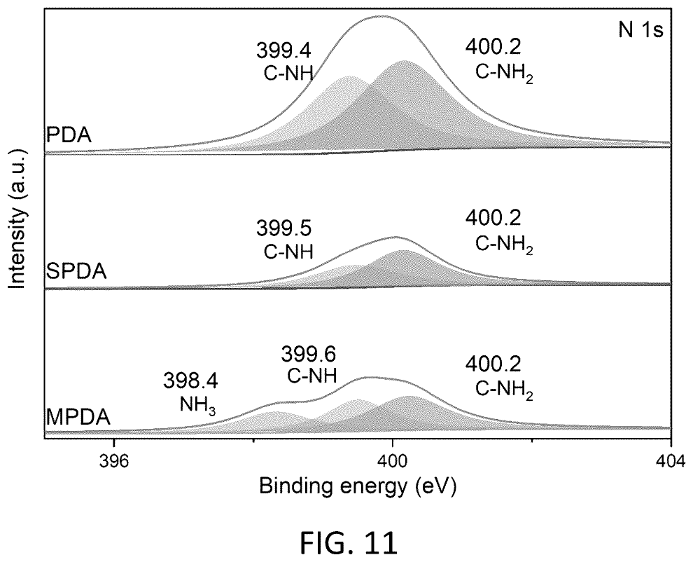

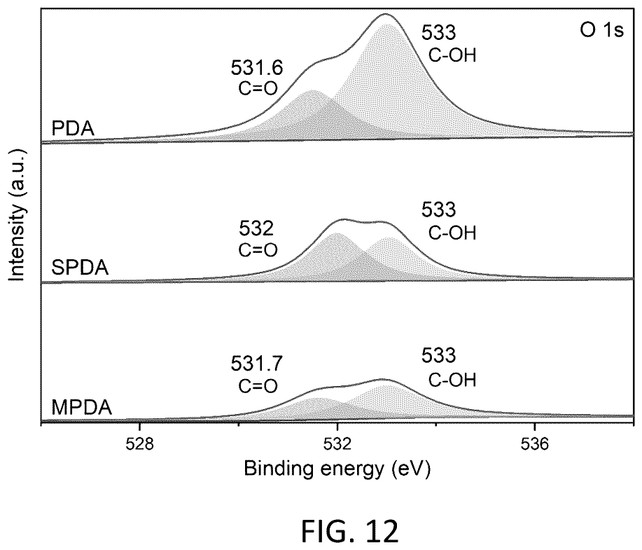

The XPS spectrum as shown in FIG. 5D demonstrates that the relative N is content of MPDA is slightly lower than that of PDA, while the relative O is content is significantly reduced. Inventors hypothesize that this is related to the heating treatment under Ar protection during the template removal process of MPDA, leading to a decrease in the content of polar functional groups (e.g., —OH, —NH₂) on the surface of the nanomaterials. Furthermore, ammonia is used during the synthesis process of MPDA to maintain the pH value of the system, introducing nitrogen-containing functional groups, thus the relative content of N element is not significantly reduced. The C is peak fitting results referring to FIG. 5E of the three types of polydopamine nanomaterials support this speculation. Compared with PDA, the content of C—OH/C—N functional groups in MPDA decreased to 23.58%. The changes in the content of functional groups were further confirmed in the N 1s spectrum as shown in FIG. 11 and O 1s spectrum as shown in FIG. 12.

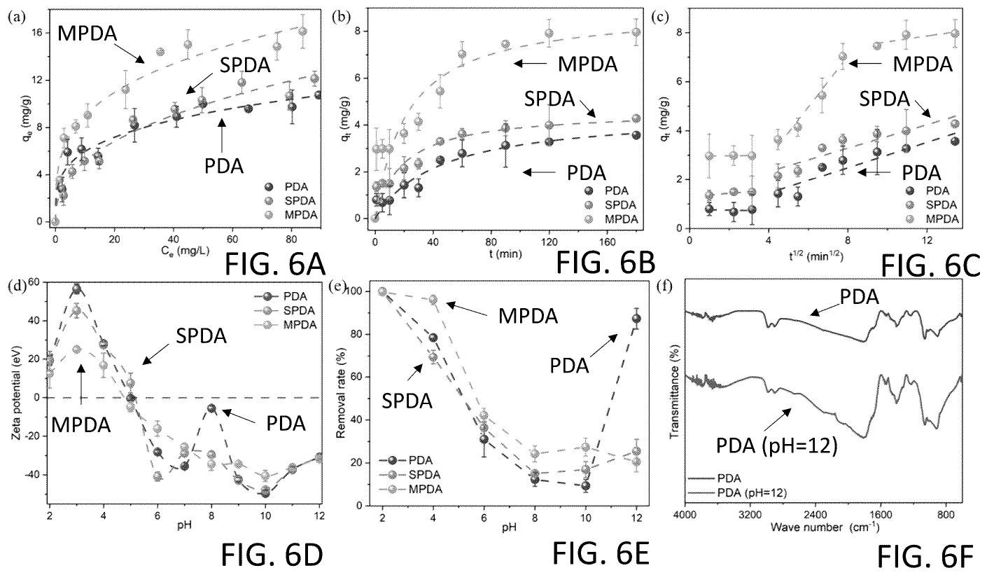

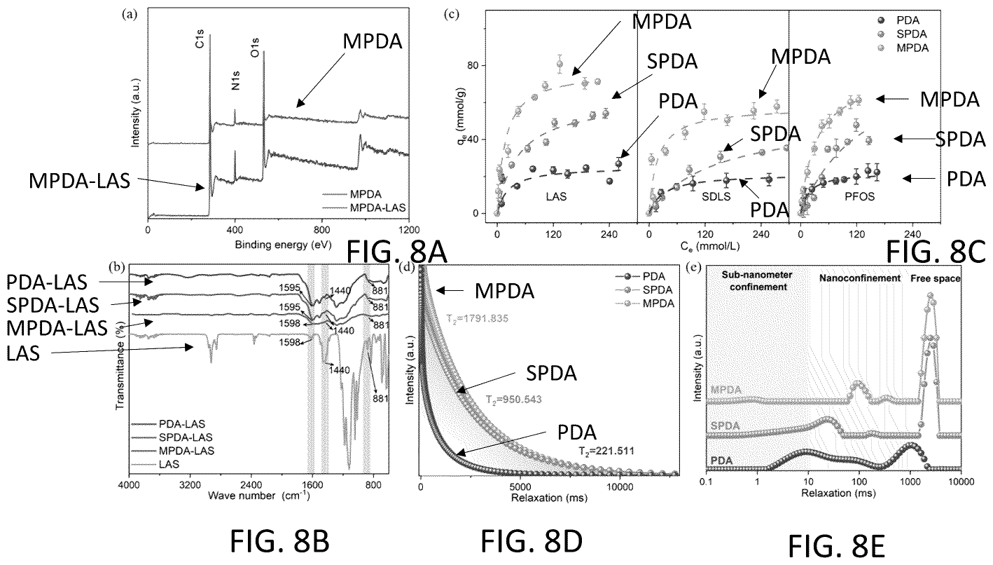

Sodium dodecyl benzene sulfonate (LAS), a typical anionic surfactant, was chosen as a representative SLC for the purpose of isotherm and kinetic fitting. A series of typical SLCs, including both conventional and perfluorinated surfactants, were also investigated to compare and contrast different adsorption mechanisms as shown in FIG. 8C. Table S3 presents the relevant parameters and correlation coefficients (R²) obtained from the Langmuir and Freundlich models. The Freundlich model is better suited for simulating the adsorption isotherm behavior of SLCs on polydopamine nanospheres as shown in FIG. 6A. This suggests that the adsorption sites of polydopamine nanospheres on SLCs exhibit heterogeneity. The fitting results of the Freundlich adsorption isotherm model reveal that the 1/n values for PDA, SPDA, and MPDA after fitting are 0.26, 0.40, and 0.28, respectively, indicating that LAS has a tendency to be adsorbed by polydopamine nanospheres. The maximum adsorption capacities of LAS on PDA, SPDA, and MPDA materials are 10.58 mg/g, 14.11 mg/g, and 16.35 mg/g, respectively, demonstrating that the mesoporous structure of MPDA can significantly enhance the adsorption capacity of LAS.

The pseudo first order adsorption kinetics model and pseudo second order adsorption kinetics model were used to obtain relevant parameters and correlation coefficient R² referring to FIG. 6B and Table S4. The kinetic fitting results show that the R² range of the polydopamine nanospheres, based on the pseudo first order adsorption kinetic model, is 0.80-0.92, while the R² range based on the pseudo second order adsorption kinetic model is 0.84-0.94. Consequently, the equilibrium adsorption capacities of PDA, SPDA, and MPDA are determined to be 4.55 mg/g, 4.62 mg/g, and 8.95 mg/g, respectively, with MPDA exhibiting the highest initial adsorption rate of 0.41 mg/min.

To further analyze the continuous adsorption process and changes in the adsorption rate of SLCs on the three biomimetic polydopamine nanomaterials, the Weber Morris model was employed to simulate the adsorption kinetics. The fitting results, shown in FIG. 6C, indicate that intra-particle diffusion alone does not control the adsorption process, as the fitted straight line does not pass through the origin. The intra-particle diffusion model typically encompasses a three-stage adsorption process, including surface diffusion, intra-particle diffusion, and dynamic equilibrium of adsorption and desorption. The fitting results reveal that the adsorption of LAS by polydopamine nanospheres can be described as the diffusion of LAS from the solution to the solid surface of the material within 0 to 10 minutes, with no significant increase in LAS adsorption during this stage. Subsequently, the LAS adsorption capacity of MPDA rapidly increases, indicating the rapid diffusion of LAS molecules into the interior of MPDA particles. However, the diffusion rate constant within the particles is relatively low due to steric hindrance on the solid surfaces of PDA and SPDA. After 90 minutes of adsorption, the adsorption rate constant of LAS on MPDA significantly decreases, and the adsorption process gradually reaches equilibrium. The adsorption rate of the three materials primarily depends on the intra-particle diffusion stage, with the surface diffusion stage playing a crucial role in limiting adsorption.

Based on the BET characterization results of the material as shown in FIG. 5B, the spherical and mesoporous modification of MPDA effectively enhanced the distribution of mesopores and specific surface area. The average pore size of MPDA increased from 4.92 nm to 7.49 nm compared to PDA, and the specific surface area increased from 26.34 m²/g to 126.52 m²/g. This increase in surface area provides more sites for SLCs to attach to the absorbents. Therefore, based on the intra-particle diffusion mechanism, when SLCs diffuse to the absorbent surface, the presence of mesoporous promotes the further migration and diffusion of SLCs molecules into the pores, thereby playing a dominant role in the adsorption process.

Zeta potential characterization results as shown in FIG. 6D reveal that the isoelectric pH values of PDA, SPDA, and MPDA are 4.75, 5.0, and 5.17, respectively, indicating a reduction in the content of surface acidic functional groups of MPDA. The adsorption and removal effects of polydopamine nanospheres on LAS under different system pH values are shown in FIG. 6E. It is observed that as the pH value of the system increases, the adsorption and removal efficiency of the absorbents significantly decrease. The pKa of LAS is 0.7, indicating that LAS carries a negative charge when the pH value of the system is greater than 0.7. When the pH value of the system exceeds 5.17, the surfaces of the absorbents become negatively charged, leading to an increase in electrostatic repulsion between MPDA and LAS, thereby reducing the adsorption capacity of LAS. Additionally, as the pH value of the system increases, the ionization of sulfonic acid groups is not significantly affected, while the ionization of the phenolic hydroxyl group gradually increases, weakening the hydrogen bonding between polydopamine nanospheres and LAS. Therefore, the decrease in adsorption capacity of LAS under high pH conditions may be attributed to the combined effect of electrostatic interaction and hydrogen bonding.

Furthermore, polydopamine is chemically synthesized from dopamine and contains a significant number of benzene ring conjugated systems. In the dopamine structure, hydroxyl and amino groups act as strong electron-donating groups, while LAS possesses a benzenesulfonic acid structure, where the sulfonic acid group acts as a moderately electron-withdrawing group. Although the carbonyl group in the dopamine structure exhibits electron-withdrawing ability, the electron-withdrawing performance of sodium sulfonate decreases in aqueous solution systems. XPS characterization results, as shown in FIG. 5E, indicate that the relative content of C—O/C—N on the polydopamine nanospheres is relatively high, which still acts as an electron donor and interacts with LAS to generate π-π electron donor-acceptor interactions. As the pH increases, the electron-withdrawing ability of sulfonic acid groups decreases, resulting in an increase in the electron cloud density of the benzene ring in the LAS structure. Similarly, the electron cloud density of the benzene ring in the polydopamine structure also increases. Hence, the π-π electron donor-acceptor interaction is relatively less affected by the pH value of the system. However, when the pH value reaches to 8, the removal capacities of the absorbents show a decrease of approximately 80%, suggesting that the electrostatic interaction in the adsorption process of polydopamine nanospheres for LAS is stronger than the π-π electron donor-acceptor interaction. Therefore, electrostatic and hydrogen bonding are important adsorption mechanisms of MPDA for LAS removal.

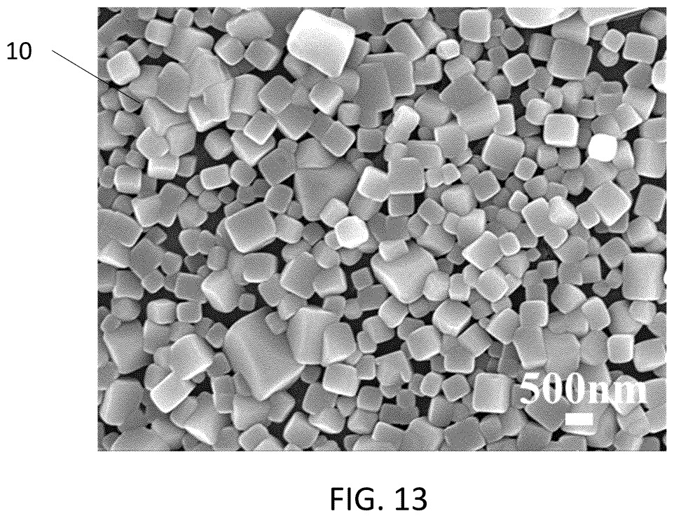

It is noteworthy that the PDA exhibits a significant improvement in removal efficiency at a pH value of 12. To investigate the reasons for this change, this study characterized the nanospheres under different pH conditions of the system using SEM. The results indicate that the change in system pH has minimal effect on the morphology and structure of SPDA and MPDA materials. However, at a pH value of 12, the PDA morphology undergoes a significant transformation. Through SEM observations of PDA at a pH value of 12 in FIG. 13, this study discovered, for the first time, that PDA changes from a disordered layered stacking morphology as shown in FIG. 5A to a dispersed cuboid structure, with particle lengths ranging from 500 nm to 800 nm. FTIR characterization of PDA material at a pH value of 12 as shown in FIG. 6F demonstrates that the pH value has no significant effect on the position and distribution of infrared characteristic peaks on the surface of PDA. The composition and distribution of the main functional groups are consistent with the original PDA material, and there is no significant difference. Therefore, the sudden increase in the adsorption capacity of PDA on LAS when the pH value of the system is 12 can be attributed to the regular cube PDA morphology.

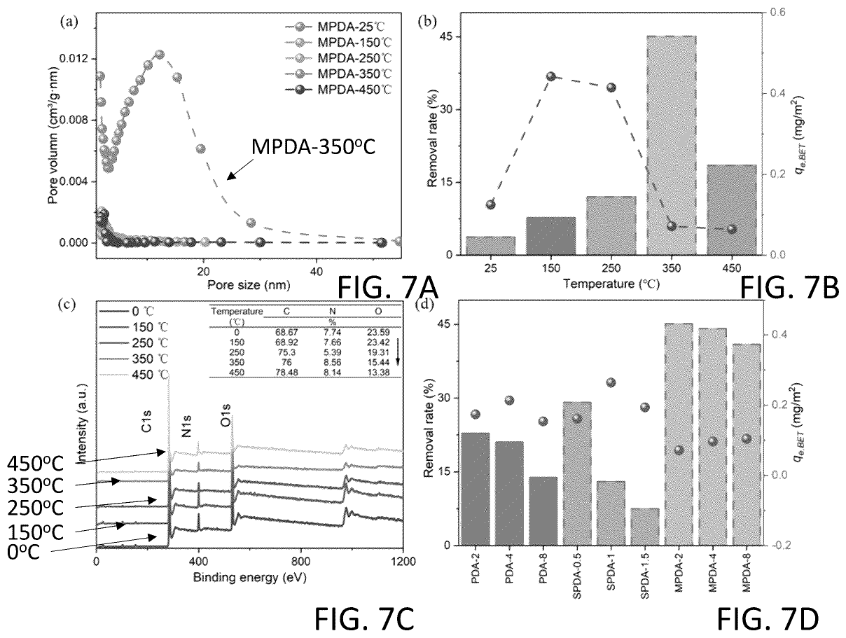

The adsorption enhancement mechanism of mesoporous morphology was further elucidated by changing the removal temperature of soft template. The specific surface area and pore size distribution of MPDA were analyzed at different temperatures, as shown in FIG. 7A and Table S5. When the template removal temperature ranged from 25° C. to 250° C., the specific surface area of MPDA showed minimal changes, indicating a lack of mesoporous structure formation and insignificant removal effect of the soft template agent. However, at a template removal temperature of 350° C., the specific surface area of MPDA significantly increased to 126.52 m²/g, with the specific surface area of BJH mesopores reaching 95.22 m²/g. This suggests that the formation of mesopores is the main factor contributing to the overall increase in specific surface area. Conversely, at a template removal temperature of 450° C., the specific surface area of MPDA decreased to 58.01 m²/g, primarily due to a significant reduction in mesoporous specific surface area to 3.86 m²/g. In this case, the specific surface area of micropores dominates.

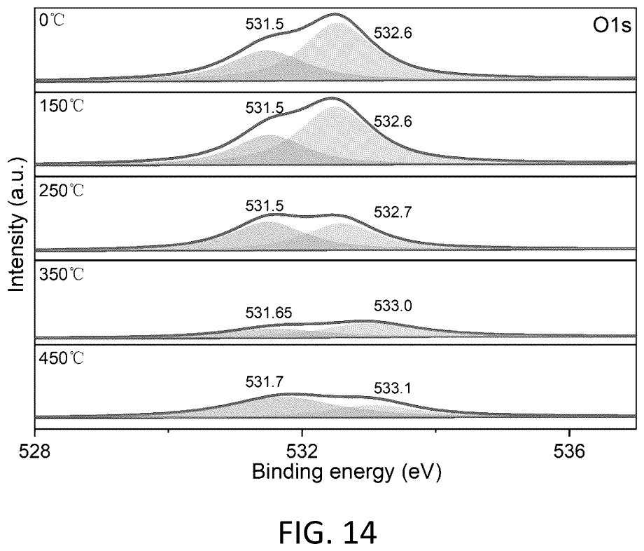

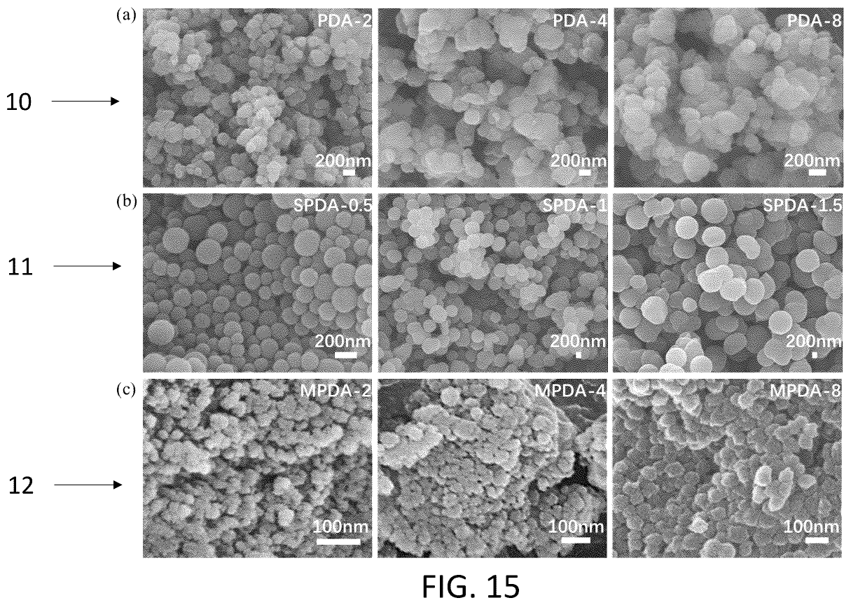

Comparing the adsorption performance of MPDA on LAS at different template removal temperatures, referring to FIG. 7B, inventors observed a consistent trend with the changes in specific surface area. MPDA-350° C. exhibited the best adsorption effect, with a LAS removal rate of 45.14%. At template removal temperatures between 25° C. and 250° C., the adsorption removal rate of LAS gradually increased, albeit with small increments, ranging from 3.75% to 12.01%. By calculating the adsorption affinity (eq. 7) of MPDA for LAS per unit specific surface area, inventors found that as the template removal temperature increased, the adsorption affinity of MPDA for LAS gradually decreased. Notably, at 350° C., there was a sudden decrease from 0.414 mg/m² to 0.0714 mg/m². The O is peak results on the MPDA surface, referring to FIG. 7C and FIG. 14, suggest that the decrease in MPDA adsorption affinity is mainly associated with the relative content of oxygen-containing functional groups on its surface. The reduction in hydroxyl groups, which possess a strong conjugation electron donating ability, diminishes the π-π interaction between MPDA and LAS, weakens hydrogen bonding, increases electrostatic repulsion, and ultimately lowers the adsorption affinity of MPDA for LAS. Furthermore, the lowest adsorption affinity observed for MPDA-350° C., which also exhibited the highest LAS removal rate, supports the notion that the mesoporous structure facilitates easy diffusion of SLCs into the absorbents, providing more adsorption sites, enhancing particle diffusion rates, and promoting the overall adsorption process. The similar tendency was also observed on the adsorption behavior with different particle size of PDA, SPDA, and MPDA, with reference to FIG. 7D and FIG. 15.

By comparing the XPS spectra before and after the adsorption of LAS by polydopamine nanospheres, as shown in FIG. 8a, the results revealed an increase in the relative content of O element and a decrease in the relative content of C element on the MPDA surface after LAS adsorption. This can be attributed to the presence of oxygen-containing sulfonic acid functional groups in the LAS structure. Additionally, FTIR spectra, referring to FIG. 8B, exhibited significant C—C bond stretching vibration peaks within the benzene ring at 1598 nm and 1440 nm, as well as a prominent C—H out of plane vibration peak on the benzene ring at 881 nm after LAS adsorption. This change was found to be consistent with the wavelength of the LAS standard sample, providing evidence for the physical adsorption effect of LAS on the adsorbents surface.

To further investigate the selective adsorption mechanism of MPDA on SLCs, a horizontal comparison was conducted using multiple SLCs, including traditional surfactants and perfluorinated compounds. The chemical properties and mass fractions of these compounds are presented in Table S6. To minimize the influence of different interaction mechanisms, an innovative approach was employed by adjusting the system pH to the isoelectric of the absorbent based on Zeta potential analysis, thus reducing the impact of electrostatic interactions. Moreover, to account for variations in the molecular weights of SLCs, their molecular weights was normalized to determine the adsorption isotherm and Langmuir model fitting results of polydopamine nanospheres for SLCs, with reference to FIG. 8C.

Under the isoelectric pH value, MPDA exhibits remarkable selective adsorption performance for SLCs, surpassing both PDA and SPDA in terms of equilibrium adsorption capacity. Moreover, the adsorption capacity of MPDA for LAS is higher than that of PFOS and SDLS, aligning with the log P-value ranking of the SLCs as shown in Table S6. This suggests that hydrophobic interactions play a significant role as an interaction mechanism in SLCs adsorption. To verify this hypothesis, the inventors employed low-field nuclear magnetic resonance (LF-NMR) to quantitatively characterize the surface hydrophilicity of the adsorbents using water molecules as probes. Based on the LF-NMR decay curve and the calculated T2 relaxation time as shown in FIG. 8D, the surface hydrophilicity of the adsorbent was found to follow the order: PDA>SPDA>MPDA. Previous studies 4 have established that T2 relaxation times between 1 ms and 10 ms correspond to sub-nanometer confinement, T2 relaxation times between 10 ms and 100 ms correspond to nanoconfinement, and T2 relaxation times greater than 100 ms correspond to free space. Thus, the multi-component inversion results, as shown in FIG. 8E, indicate that the non-free water components of PDA primarily consist of water located at the sub-nano and nanometer confinement. For MPDA, the non-free water is mainly concentrated in the mesopores on the surface of MPDA and the nanopores between particles, indicating relatively weak surface hydrophilicity and water molecule distribution primarily occurring on the MPDA surface through capillarity. It is noteworthy that despite exhibiting the highest hydrophilic performance, PDA shows no significant difference in adsorption capacity for the three types of SLCs. This result confirms that hydrophobic interactions are the key interaction mechanism for the selective removal of SLCs.

The absence of a benzene ring structure in SDLS and PFOS, along with the lack of significant difference in adsorption capacity of polydopamine nanospheres for LAS and PFOS, suggests that the π-π electron donor-acceptor interaction mechanism has minimal impact on the selective removal of SLCs. Conversely, the analysis of pH value impact as shown in FIG. 7E and LF-NMR analysis highlight the importance of electrostatic and hydrophobic interactions as interaction mechanisms for the selective removal of SLCs by MPDA. The mesoporous structure of MPDA, resulting in an increase in specific surface area, further enhances its selective removal ability for SLCs.

Preferably, MPDA provided in accordance with embodiments of the present invention may be used for removing a predetermined amount of SLCs from wastewater, and furthermore, MPDA may be recycled by removing SLCs from the polydopamine particles to regenerate an SLC removal power of the MPDA. For example, SLCs may be removed from the polydopamine particles by undergoing a SLCs desorption process where ethanol maybe used as an eluant to remove SLCs from the MPDA nanoparticle surfaces.

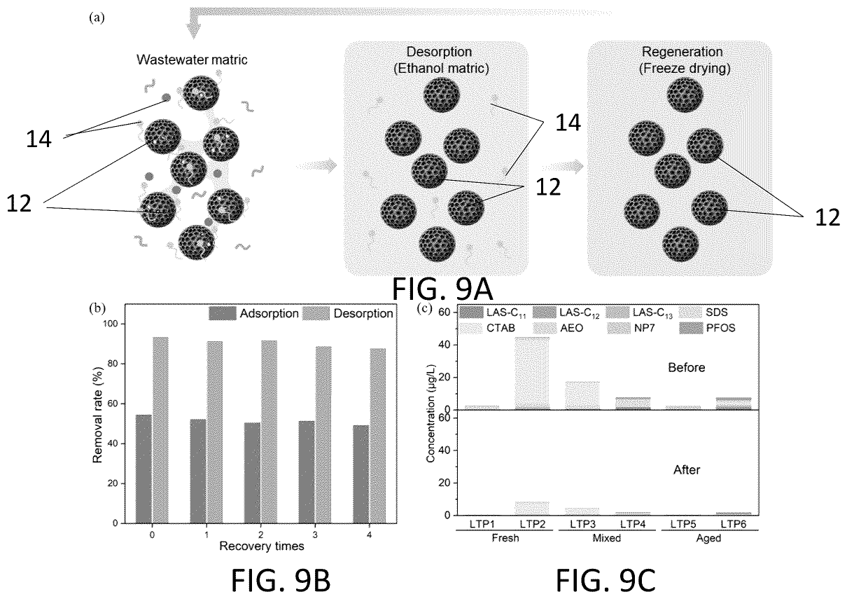

The significant role of hydrophobic interactions in the selective removal of SLCs on MPDA is demonstrated in this study, inspiring targeted and effective strategies for SLCs removal and MPDA cycling in wastewater matrices, referring to FIG. 9A. Following the removal of SLCs from practical wastewater, the absorbed SLCs were desorbed from MPDA using ethanol as the eluant. The adsorption and desorption rates of LAS on MPDA were tested five times as shown in FIG. 9B, revealing only a minimal decrease of 5.3% in the adsorption rate and 5.7% in the desorption rate. This ethanol-based desorption method effectively inhibits the hydrophobic interaction between MPDA and SLCs, facilitating the desorption of SLCs. After rinsing and freeze-drying, the regenerated MPDA was successfully reused for SLCs removal in wastewater matrices.

To validate this strategy, nanofiltration concentrate (NFC) samples were collected from six municipal solid waste (MSW) leachate treatment plants (LTPs). MSW leachate, with organic contaminants concentration over ten times higher than sewage wastewater and a total organic carbon (TOC) ranging from 3000 mg/L to 10000 mg/L, was chosen for testing. To minimize the impact of different leachate sources and compositions, NFC was selected as the sample instead of raw leachate. Moreover, the NFC treatment process in LTPs is known for severe foaming issues, highlighting the urgent need for the selective removal of SLCs. 8 types of SLCs, including conventional and perfluorinated surfactants, were quantified in all leachate samples before and after MPDA adsorption. The results, referring to FIG. 9C, demonstrated the effective removal of SLCs by MPDA, with a 76.3% reduction in the total concentration of the eight SLC types after adsorption. The average removal rate for ionic surfactants and PFOS was found to be 87.5%, which can be attributed to the higher hydrophobicity and the acidic pH system (all samples had a pH value lower than 7). It is worth noting that the initial total concentration of the eight SLC types in the six leachate samples was below 50 g/L before MPDA removal, despite the presence of more than 1000 mg/L of TOC. This indicates that MPDA selectively adsorbed micro or trace amounts of SLCs within the complex wastewater matrices.

In this study, inventors aimed to elucidate the selective adsorption mechanisms of SLCs on mesoporous polydopamine nanospheres. Through the implementation of LF-NMR characterization, inventors quantitatively characterized the surface hydrophilicity of the absorbents using water molecules as probes. Results confirmed the presence of hydrophobic interactions between mesoporous polydopamine nanospheres and SLCs. Moreover, by manipulating the system's pH to reach the isoelectric point and conducting a comparative analysis of SLCs with different chemical structures, inventors highlighted the significant role of electrostatic and hydrophobic interactions as the mechanisms for the selective removal of SLCs.

These mechanistic insights provide critical information for the design of selective SLCs removal absorbents. With the application results in highly contaminated wastewater matrices, inventors highlight the significant potential of mesoporous polydopamine nanospheres as efficient adsorbents in complex wastewater. The hydrophilicity quantitation methods based on LF-NMR offer a feasible strategy for the potential application of mechanism elucidation on powder nanomaterials. Overall, new avenues for the development of targeted and effective SLCs removal strategies are devised, with potential implications for the broader field of wastewater treatment.

These embodiments may be advantageous in that a novel method is provided for fabricating mesoporous polydopamine nanostructures (MPDA) utilizing a soft-template. The engineered MPDA display spherical nano-architectures with mesoporous features, which may enhance the removal efficiency of SLCs. Based on the intra-particle diffusion mechanism, the presence of mesoporous promotes the further migration and diffusion of SLCs molecules into the pores upon their diffusion to the absorbent surface, thereby playing a crucial role in enhancing the adsorption process.

Advantageously, the adsorption capacity of PDA may be substantially enhanced by providing the MPDA nanostructure, and the MPDA possesses high removal efficiency of SLCs due to the fast intra-particle diffusion rate, which may be useful in selective and targeted SLCs removal in wastewater treatment, and thus a practical strategy for the potential application of MPDA is provided.

Advantageously, the designed non-toxic and mesoporous polydopamine nanostructures may be applied as selective and efficient absorbents to remove SLCs.

Supported by the experiments performed by the inventors, based on the soft-template synthesis process, MPDA contains a stable mesoporous nanostructure structure that enhances the intra-particle diffusion in SLCs removal. In addition, the fabrication method is unique as the process involve non-ionic surfactant served as a soft-template for the formation of the mesoporous morphology of MPDA. In addition, an optimized polydopamine polymerization technique facilitates obtaining a high BET surface area and corresponding high removal efficiency for SLCs.

In addition, the inventors devised that low-field nuclear magnetic resonance may be employed to quantitatively characterize the hydrophilicity of the absorbents using water molecules as probes. The results demonstrated that MPDA with uniform mesopores exhibited a remarkable 3-fold enhancement in SLCs adsorption capacity compared to polydopamine particles via intra-particle diffusion.

Advantageously, the selective and efficient removal of SLCs is achieved by MPDA, featuring regulated mesoporous nanostructure morphology. The designed MPDA promotes the intra-particle diffusion and enhances the hydrophobic interactions between absorbents and SLCs, resulting in a significantly increase in the targeted SLCs removal.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

TABLE S1
Time trends of the composition of mobile phase A (5 mM/L
ammonium acetate + 0.5% formic acid) and B (MeOH).

| Time | Phase A | Phase B |
|---|---|---|
| (min) | (%) | (%) |
| 0-4 | 90 | 10 |
| 4-12 | 60 | 40 |
| 12-14 | 30 | 70 |
| 14-28 | 5 | 95 |
| 28-34 | 90 | 10 |
| — | — | — |

TABLE S2
Mass spectrum conditions of SLCs.

| | Parent | Daughter | Collision | Cone | Retention |
|---|---|---|---|---|---|
| | ion | ion | energy | voltage | time |
| Surfactants | (m/z) | (m/z) | (V) | (V) | (min) |
| LAS | 325.16 | 197.054 | 68 | 32 | 15.69 |
| SDLS | 249.114 | 79.8479 | 58 | 28 | 15.22 |
| PFOS | 498.88 | 80.04 | 44 | 60 | 14.42 |

TABLE S3
Adsorption isotherms parameters for LAS adsorption.

| | | | | Fre [symbol] |
|---|---|---|---|---|
| | | | | und [symbol] |
| | | | | lich [symbol] |
| | | | | K_{f} [symbol] |
| | | | | ( [symbol] |
| | | | | mg [symbol] |
| | | | | · (L [symbol] |
| | | | | /m [symbol] |
| | Langmuir | | | g)¹ [symbol] |
| | qₘ | b | | ^{/n}/g [symbol] |
| Materials | (mg/g) | (L/mg) | R² | ) |
| PDA | 10.58 ± 0.62 | 0.162 ± 0.046 | 0.8704 | [symbol] |
| | | | | [symbol] |
| | | | | 3.2 [symbol] |
| | | | | 3 ± [symbol] |
| | | | | 0.4 [symbol] |
| | | | | 3 [symbol] |
| | | | | [symbol] |
| | | | | [symbol] |
| SPDA | 14.11 ± 0.84 | 0.056 ± 0.010 | 0.9627 | [symbol] |
| | | | | [symbol] |
| | | | | 2.0 [symbol] |
| | | | | 3 ± [symbol] |
| | | | | 0.3 [symbol] |
| | | | | 2 [symbol] |
| | | | | [symbol] |
| | | | | [symbol] |
| MPDA | 16.35 ± 0.91 | 0.158 ± 0.038 | 0.9285 | [symbol] |
| | | | | [symbol] |
| | | | | 4.6 [symbol] |
| | | | | 5 ± [symbol] |
| | | | | 0.5 [symbol] |
| | | | | 2 [symbol] |
| | | | | [symbol] |
| | | | | [symbol] |

[symbol]

indicates data missing or illegible when filed

TABLE S4
Kinetics parameters for LAS adsorption.

| | Pseudo-first-order kinetic model | | | Pseudo-second-order kinetic model | | |
|---|---|---|---|---|---|---|
| | qₑ | k₁ | | qₑ | k₂ | |
| Materials | (mg/g) | (mg/g/min) | R² | (mg/g) | (g/mg/min) | R² |
| PDA | 3.59 ± 0.27 | 0.023 ± 0.005 | 0.9198 | 4.55 ± 051 | 0.005 ± 0.002 | 0.9417 |
| SPDA | 4.04 ± 0.31 | 0.040 ± 0.01 | 0.9017 | 4.62 ± 0.42 | 0.011 ± 0.005 | 0.9017 |
| MPDA | 7.83 ± 0.78 | 0.034 ± 0.010 | 0.8003 | 8.95 ± 1.10 | 0.0051 ± 0.0027 | 0.8417 |

TABLE S5
Surface area of MPDA at different template removal temperatures.

| Surface area | MPDA-25° C. | MPDA-150° C. | MPDA-250° C. | MPDA-350° C. | MPDA-450° C. |
|---|---|---|---|---|---|
| BET surface area | 6.03 | 3.50 | 5.80 | 126.52 | 58.01 |
| BJH surface area | 4.84 | 3.09 | 5.43 | 95.22 | 3.86 |
| t-Plot micropore | 1.89 | 1.04 | 1.26 | 35.93 | 56.52 |
| area | | | | | |
| t-Plot external | 4.15 | 2.46 | 4.54 | 90.59 | 1.49 |
| surface area | | | | | |

What is claimed is:

1. A method for fabricating a liquid contaminant absorbent, comprising the steps of:
mixing polydopamine nanospheres (SPDA) with a template agent in a predetermined mixing ratio to form a precursor mixture;
dissolving the precursor mixture in a solvent to initiate a reaction within the precursor mixture;
obtaining a precipitate from the precursor mixture after a predetermined reaction period; and
removing the template agent from the precipitate to obtain mesoporous polydopamine nanoparticles (MPDA).

2. The method of claim 1, wherein the template agent includes a non-ionic surfactant.

3. The method of claim 2, wherein the template agent includes a plutonic F-127 template agent.

4. The method of claim 3, wherein the step of dissolving the precursor mixture in a solvent to initiate a reaction within the precursor mixture comprises the step of adjusting a system pH of the precursor mixture with an alkaline solution and maintaining the precursor mixture at a predetermined reaction temperature in the predetermined reaction period.

5. The method of claim 4, wherein the system pH is adjusted to 8.5, the predetermined reaction period is 24 hours and the predetermined reaction temperature is 80 degrees Celsius.

6. The method of claim 2, wherein the step of removing the template agent from the precipitate comprises the step of baking the precipitate at a predetermined baking temperature for a predetermined baking period.

7. The method of claim 6, wherein the predetermined baking temperature is in a range between 250 to 450 degrees Celsius.

8. The method of claim 7, wherein the predetermined baking temperature is at 350 degree Celsius.

9. The method of claim 2, further comprising the step of preparing SPDA by:
dissolving and stirring dopamine in Tris-HCl buffer solution for 24 hours at room temperature;
obtaining pristine polydopamine nanoparticles (PDA) by freeze-frying precipitate separated from the mixture of dopamine in Tris-HCl buffer solution;
dissolving and stirring PDA in ethanol and Tris-HCl buffer solution for 24 hours; and
obtaining SPDA by freeze-drying precipitate separated from the mixture of PDA in ethanol and Tris-HCl buffer solution.

10. A liquid contaminant absorbent comprising polydopamine particles having mesoporous nanostructures formed on a surface of the polydopamine particles.

11. The liquid contaminant absorbent of claim 10, wherein the polydopamine particles is adapted to remove surfactant-like contaminants (SLCs) from wastewater.

12. The liquid contaminant absorbent of claim 11, wherein the polydopamine particles is arranged to remove SLCs from wastewater by adsorption.

13. The liquid contaminant absorbent of claim 10, wherein the polydopamine particles are fabricated in accordance with the steps of:
mixing polydopamine nanospheres (SPDA) with a template agent in a predetermined mixing ratio to form a precursor mixture;
dissolving the precursor mixture in a solvent to initiate a reaction within the precursor mixture;
obtaining a precipitate from the precursor mixture after a predetermined reaction period; and
removing the template agent from the precipitate to obtain mesoporous polydopamine nanoparticles (MPDA).

14. A method of regenerating a liquid contaminant absorbent for removing SLCs from wastewater, comprising the step of providing polydopamine particles having mesoporous nanostructures formed on a surface of the polydopamine particles, the polydopamine particles being used for removing a predetermined amount of SLCs from wastewater, and removing SLCs from the polydopamine particles to regenerate an SLC removal power of the polydopamine particles having mesoporous nanostructures.

15. The method of claim 13, wherein the step of removing SLCs from the polydopamine particles includes a SLCs desorption process.

16. The method of claim 14, wherein the polydopamine particles are processed by ethanol as an eluant to remove the SLCs from the surface of the polydopamine particles.
